(19) United States
(12) Patent Application Publication
(10) Pub. No.: US 2017/0169122 A1
(43) Pub. Date: Jun. 15, 2017

(54) WEBPAGE DISPLAY METHOD, MOBILE TERMINAL, INTELLIGENT TERMINAL, PROGRAM AND STORAGE MEDIUM

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventor: Zhen LI, Beijing (CN)

(73) Assignees: LE HOLDINGS (BEIJING) CO., LTD., Beijing (CN); LE SHI ZHI XIN ELECTRONIC TECHNOLOGY (TIANJIN) LIMITED, Beijing (CN)

(21) Appl. No.: 15/246,187

(22) Filed: Aug. 24, 2016

Related U.S. Application Data
(63) Continuation of application No. PCT/CN2016/088635, filed on Jul. 5, 2016.

(30) Foreign Application Priority Data
Dec. 10, 2015 (CN) 201510925739.8

(51) Int. Cl. G06F 17/30; G06F 3/0482; H04L 29/08

(52) U.S. Cl. CPC G06F 17/30899; H04L 67/146; G06F 3/0482; H04W 88/02

(57) ABSTRACT

The present disclosure provides a webpage display method based on a link identifier, a mobile terminal, an intelligent terminal, a computer program, a storage medium and an apparatus, and relates to the field of communications technology. In the present disclosure, the mobile terminal sends an access request including a website home page address to the intelligent terminal according to a link identifier, receives and displays a website home page corresponding to the website home page address sent by the intelligent terminal, detects an instruction input by a user on the website home page, determines a webpage address of a webpage to be browsed according to the instruction, and sends the webpage address of the webpage to be browsed to the intelligent terminal, thus allowing the intelligent terminal to display the webpage to be browsed corresponding to the webpage address of the webpage to be browsed.

### CROSS-REFERENCE TO RELATED APPLICATIONS

The present disclosure is a continuation of International Application No. PCT/CN2016/088635, filed on Jul. 5, 2016, which is based upon and claims priority to Chinese Application No. 201510925739.8, filed on Dec. 10, 2015, the entire contents of which are incorporated herein by reference.

### TECHNICAL FIELD

The present disclosure relates to the field of video image processing technology, and in particular, to a webpage display method based on a link identifier, a mobile terminal, an intelligent terminal, a computer program, a storage medium and an apparatus.

### BACKGROUND

With the development of technology, an intelligent terminal (such as a smart TV and other devices) is also more and more intelligent, a user can complete a lot of demands on the intelligent terminal, for example, browsing a webpage on the intelligent terminal; and

in a process of implementing the present disclosure, the inventor finds that the prior art has at least the following problems: when browsing the webpage on the intelligent terminal, the operation is carried out by a remote controller in general, no matter when a browser is operated by the remote controller or when texts are input by the remote controller, there's a problem of inconvenient operation, resulting in lower user experience.

### SUMMARY

The object of embodiments of the present disclosure is to provide a mobile terminal, a webpage display method based on a link identifier, an intelligent terminal and another webpage display method based on a link identifier, in order to solve or at least partially solve the problem that inconvenient operation in the prior art results in lower user experience.

On one aspect, the embodiments of the present disclosure provide a mobile terminal, including:

at least one processor; and

a memory communicably connected with the at least one processor for storing instructions executable by the at least one processor, wherein execution of the instructions by the at least one processor causes the at least one processor to:

send an access request including a website home page address to an intelligent terminal according to a link identifier, wherein the link identifier is generated based on the website home page address and the address of the intelligent terminal;

receive and display a website home page corresponding to the website home page address sent by the intelligent terminal;

detect an instruction input by a user on the website home page and determine a webpage address of a webpage to be browsed according to the instruction; and

send the webpage address of the webpage to be browsed to the intelligent terminal, thus allow the intelligent terminal to display the webpage to be browsed corresponding to the webpage address of the webpage to be browsed.

On another aspect, the embodiments of the present disclosure further provide a webpage display method based on a link identifier, including:

sending an access request including a website home page address to an intelligent terminal according to the link identifier, wherein the link identifier is generated based on the website home page address and the address of the intelligent terminal;

receiving and displaying a website home page corresponding to the website home page address sent by the intelligent terminal;

detecting an instruction input by a user on the website home page, and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

On another aspect, the embodiments of the present disclosure further provide an intelligent terminal, including:

at least one processor; and

a memory communicably connected with the at least one processor for storing instructions executable by the at least one processor, wherein execution of the instructions by the at least one processor causes the at least one processor to:

when receive an access request including a website home page address and sent by a mobile terminal according to a link identifier, send a website home page corresponding to the website home page address to the mobile terminal, wherein the link identifier is generated based on the website home page address and the address of the intelligent terminal;

receive a webpage address of a webpage to be browsed sent by the mobile terminal, wherein the webpage address of the webpage to be browsed is determined by an instruction input by a user on the website home page; and

obtain the webpage to be browsed based on the webpage address of the webpage to be browsed and displaying the webpage to be browsed.

On another aspect, the embodiments of the present disclosure further provide a webpage display method based on a link identifier, including:

when receiving an access request including a website home page address and sent by a mobile terminal according to the link identifier, sending a website home page corresponding to the website home page address to the mobile terminal, wherein the link identifier is generated based on the website home page address and the address of the intelligent terminal;

receiving a webpage address of a webpage to be browsed sent by the mobile terminal, wherein the webpage address of the webpage to be browsed is determined by an instruction input by a user on the website home page; and

obtaining the webpage to be browsed based on the webpage address of the webpage to be browsed, and displaying the webpage to be browsed.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a webpage display method based on a link identifier provided by some embodiments of the present disclosure;

FIG. 2 is a flowchart of a webpage display method based on a link identifier provided by some embodiments of the present disclosure;

FIG. 3 is a flowchart of a webpage display method based on a link identifier provided by some embodiments of the present disclosure;

FIG. 4 is a flowchart of a webpage display method based on a link identifier provided by some embodiments of the present disclosure;

FIG. 5 is a flowchart of a webpage display method based on a link identifier provided by some embodiments of the present disclosure;

FIG. 6 is a structural block diagram of a mobile terminal provided by some embodiments of the present disclosure;

FIG. 7 is a structural block diagram of an intelligent terminal provided by some embodiments of the present disclosure.

### DETAILED DESCRIPTION

In order to make the objects, technical solutions and advantages of the present disclosure clearer, a clear and complete description of technical solutions in the embodiments of the present disclosure will be given below, in combination with the accompanying drawings in the embodiments of the present disclosure. Apparently, the embodiments described below are merely a part, but not all, of the embodiments of the present disclosure. All of other embodiments, obtained by those of ordinary skill in the art based on the embodiments of the present disclosure without any creative effort, fall into the protection scope of the present disclosure.

In order to solve the problem in the prior that the inconvenient operation of browsing a webpage on an intelligent terminal by a remote controller results in lower user experience, in the embodiments of the present disclosure, a mobile terminal sends an access request including a website home page address to the intelligent terminal according to a link identifier, receives and displays a website home page corresponding to the website home page address sent by the intelligent terminal, detects an instruction input by a user on the website home page, determines a webpage address of a webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

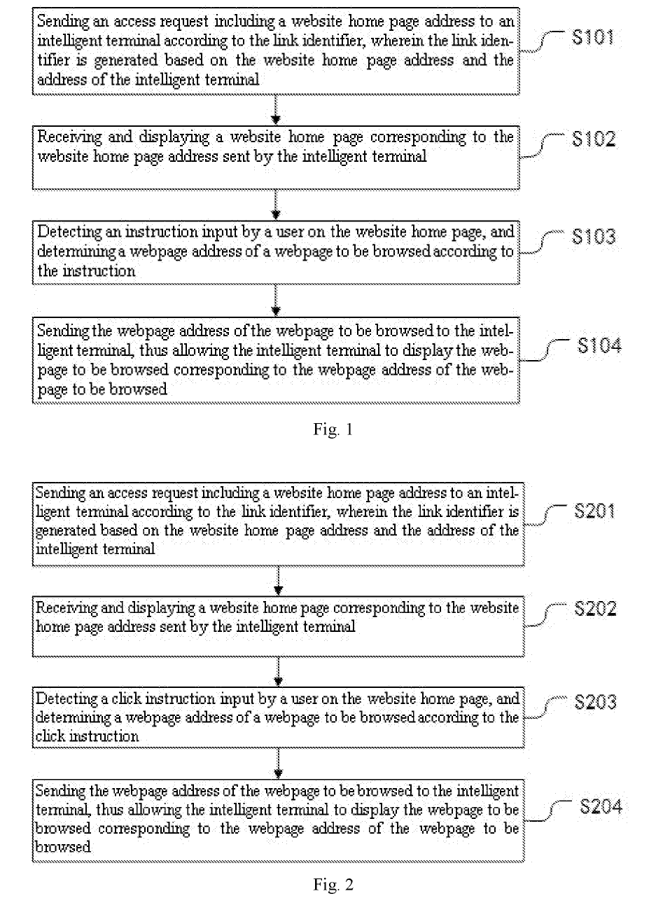

The embodiments of the present disclosure are used in a scenario in which the user operates on the mobile terminal to display the webpage to be browsed on the intelligent terminal. FIG. 1 is a flowchart of a webpage display method based on a link identifier provided by one embodiment of the present disclosure. Refer to FIG. 1, the method includes:

S101: an access request including a website home page address is sent to an intelligent terminal according to the link identifier, wherein the link identifier is generated based on the website home page address and the address of the intelligent terminal; and

it should be noted that the access request including the website home page address is sent to the intelligent terminal according to the link identifier in a variety of manners, in order to facilitate sending the access request including the website home page address to the intelligent terminal, in the embodiment, the link identifier is scanned to send the access request including the website home page address to the intelligent terminal, of course, the access request can also be sent to the intelligent terminal in other manners, and this is not limited in the embodiment.

It can be understood that an executive body of the method in the embodiment is the mobile terminal, the mobile terminal is a mobile phone, a tablet computer, a palm computer PDA or a notebook computer and other terminal devices with similar functions, and this is not limited in the embodiment of the present disclosure.

In specific implementation, the link identifier can be a two-dimension code, a barcode and other identifiers displayed on a display interface of the intelligent terminal, so the link identifier can be stored in the intelligent terminal, and furthermore, for the consideration of the space utilization rate and other requirements during the display on the display interface of the intelligent terminal, the link identifier is optionally the two-dimension code.

The website home page address is an entry address linking the website home page, for example, a uniform resource locator (URL), an IP address or an MAC address or the like, and this is not limited in the embodiment.

The address of the intelligent terminal is an address that can be used for positioning the location of the intelligent terminal, for example, the IP address or the MAC address or the like, and this is not limited in the embodiment.

S102: a website home page corresponding to the website home page address sent by the intelligent terminal is received and displayed; and

to facilitate guiding the operation of the user, the website home page is generally a navigation page similar to hao123 or the like, of course, the website home page can also be websites of other types, and this is not limited in the embodiment.

In specific implementation, the website home page is a website home page stored in the intelligent terminal, it can be understood that the website home page is collected in a network by an Internet worm and other tools and is stored on a memory of the intelligent terminal, it can also be understood that the website home page operates in the intelligent terminal, namely, the intelligent terminal is used as a background server of the website home page, of course, other situations can also exist, and this is not limited in the embodiment.

S103: an instruction input by the user on the website home page is detected, and a webpage address of a webpage to be browsed is determined according to the instruction; and

in specific implementation, the instruction input by the user on the website home page can be understood as an instruction that is input by the user via a touch screen or a keyboard and other components of the mobile terminal based on the website home page displayed in the display interface of the mobile terminal.

S104: the webpage address of the webpage to be browsed is sent to the intelligent terminal, thus allowing the intelligent terminal to display the webpage to be browsed corresponding to the webpage address of the webpage to be browsed.

In the step, after obtaining the webpage to be browsed, the intelligent terminal can directly invoke a browser interface in the intelligent terminal, a browser coming with the intelligent terminal loads the webpage to be browsed, and thus the webpage to be browsed is displayed in the display interface of the intelligent terminal.

In the embodiment, the mobile terminal sends the access request including the website home page address to the intelligent terminal according to the link identifier, receives and displays the website home page corresponding to the website home page address sent by the intelligent terminal, detects the instruction input by the user on the website home page, determines the webpage address of the webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

FIG. 2 is a flowchart of a webpage display method based on a link identifier provided by one embodiment of the present disclosure. Refer to FIG. 2, the method includes:

S201: an access request including a website home page address is sent to an intelligent terminal according to the link identifier, wherein the link identifier is generated based on the website home page address and the address of the intelligent terminal;

S202: a website home page corresponding to the website home page address sent by the intelligent terminal is received and displayed; and

steps S201 to S202 in the embodiment are the same as steps S101 to S102 in the embodiment as shown in FIG. 1, and thus will not be repeated redundantly herein.

S203, a click instruction input by the user on the website home page is detected, and a webpage address of a webpage to be browsed is determined according to the click instruction;

in specific implementation, the step can be understood as follows: since the website home page is displayed in the display interface of the mobile terminal, if a touch screen is arranged on the display interface of the mobile terminal, the user can directly click a webpage entry element of the website home page on the display interface so as to input the click instruction, after detecting the click instruction input by the user on the website home page, the mobile terminal determines the corresponding webpage entry element according to the click instruction, and uses the website home page reflected by the webpage entry element as the webpage address of the webpage to be browsed; and

if no touch screen is arranged on the display interface of the mobile terminal, the website home page displayed in the display interface of the mobile terminal carries a cursor, the user can click the webpage entry element of the website home page by the cursor according to the keyboard and other components so as to input the click instruction, after detecting the click instruction input by the user on the website home page, the mobile terminal determines the corresponding webpage entry element according to the click instruction, and uses the website home page reflected by the webpage entry element as the webpage address of the webpage to be browsed.

It can be understood that after determining the webpage address of the webpage to be browsed, the mobile terminal generally displays the webpage to be browsed on the display interface of the mobile terminal.

S204: the webpage address of the webpage to be browsed is sent to the intelligent terminal, thus allowing the intelligent terminal to display the webpage to be browsed corresponding to the webpage address of the webpage to be browsed.

Different from the embodiment as shown in FIG. 1, in the embodiment, a preset element similar to a switch function is arranged on the website home page, after the user triggers the preset element on the website home page, the webpage address of the webpage to be browsed is sent to the intelligent terminal, when the user does not trigger the preset element on the web site home page, the webpage to be browsed is directly displayed on the mobile terminal, and the webpage address of the webpage to be browsed is not sent to the intelligent terminal, so that the user can actively determine whether to send the webpage to be browsed to the intelligent terminal or not, the privacy of the user of the mobile terminal is guaranteed to a certain extent, and the user experience is improved.

The preset element can be various elements (for example, a button and other elements) for triggering on the website home page, and this is not limited in the embodiment.

FIG. 3 is a flowchart of a webpage display method based on a link identifier provided by one embodiment of the present disclosure. Refer to FIG. 3, the method includes:

S301: an access request including a website home page address is sent to an intelligent terminal according to the link identifier, wherein the link identifier is generated based on the website home page address and the address of the intelligent terminal;

S302: a website home page corresponding to the website home page address sent by the intelligent terminal is received and displayed; and

steps S301 to S302 in the embodiment are the same as steps S201 to S202 in the embodiment as shown in FIG. 2, and thus will not be repeated redundantly herein.

S303, a webpage address input by the user on the website home page is detected, and the input webpage address is used as the webpage address of a webpage to be browsed; and

it should be noted that the webpage address input by the user on the website home page is detected in the embodiment, so the webpage to be browsed is a webpage corresponding to the address (the address is an address of a webpage in a video website in general, of course, can also be an addresses of a webpage in other website, and this is not limited in the embodiment) input by the user, and the webpage browsing flexibility of the user is improved.

In specific implementation, the step can be understood as obtaining the address input by the user in an edit box of the website home page and using the webpage corresponding to the address as the webpage to be browsed.

S304: the webpage address of the webpage to be browsed is sent to the intelligent terminal, thus allowing the intelligent terminal to display the webpage to be browsed corresponding to the webpage address of the webpage to be browsed.

Step S304 in the embodiment is the same as step S204 as shown in FIG. 2, and thus will not be repeated redundantly herein.

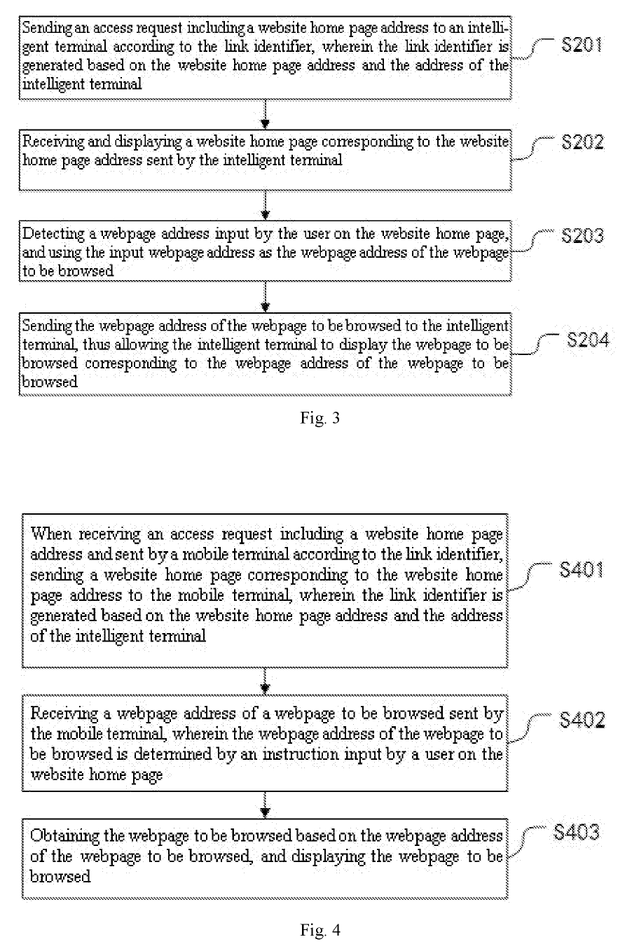

FIG. 4 is a flowchart of a webpage display method based on a link identifier provided by one embodiment of the present disclosure. Refer to FIG. 4, the method includes:

S401: when receiving an access request including a website home page address and sent by a mobile terminal according to the link identifier, a website home page corresponding to the website home page address is sent to the mobile terminal, wherein the link identifier is generated based on the website home page address and the address of the intelligent terminal; and

it can be understood that an executive body of the method in the embodiment is the intelligent terminal, the intelligent terminal is a smart TV or other terminal devices with similar functions, and this is not limited in the embodiment of the present disclosure.

In specific implementation, the link identifier can be a two-dimension code, a barcode and other identifiers displayed on a display interface of the intelligent terminal, so the link identifier can be stored in the intelligent terminal, and furthermore, for the consideration of the space utilization rate and other requirements during the display on the display interface of the intelligent terminal, the link identifier is optionally the two-dimension code.

The website home page address is an entry address linking the website home page, for example, a uniform resource locator (URL), an IP address or an MAC address or the like, and this is not limited in the embodiment.

The address of the intelligent terminal is an address that can be used for positioning the location of the intelligent terminal, for example, the IP address or the MAC address or the like, and this is not limited in the embodiment.

S402: a webpage address of a webpage to be browsed sent by the mobile terminal is received, wherein the webpage address of the webpage to be browsed is determined by an instruction input by a user on the website home page; and

in specific implementation, the website home page is a website home page stored in the intelligent terminal, it can be understood that the website home page is collected in a network by an Internet worm and other tools and is stored on a memory of the intelligent terminal, it can also be understood that the website home page operates in the intelligent terminal, namely, the intelligent terminal is used as a background server of the website home page, of course, other situations can also exist, and this is not limited in the embodiment.

When the intelligent terminal is used as the background server of the website home page, since the intelligent terminal in the prior art is generally based on an Android platform, a background server based on the Android platform needs to be edited in the intelligent terminal, so that the intelligent terminal is used as the background server of the website home page, of course, the edition of the background server based on the Android platform is prior art, and thus will not be repeated redundantly herein in the embodiment.

To facilitate guiding the operation of the user, the website home page is generally a navigation page similar to hao123 or the like, of course, the website home page can also be websites of other types, and this is not limited in the embodiment.

S403: the webpage to be browsed is obtained based on the webpage address of the webpage to be browsed, and the webpage to be browsed is displayed.

In the step, after obtaining the webpage to be browsed, the intelligent terminal can directly invoke a browser interface in the intelligent terminal, a browser of the intelligent terminal loads the webpage to be browsed, and thus the webpage to be browsed is displayed in the display interface of the intelligent terminal.

FIG. 5 is a flowchart of a webpage display method based on a link identifier provided by one embodiment of the present disclosure. Refer to FIG. 5, the method includes:

S500: the link identifier is generated based on a website home page address and the address of an intelligent terminal, and the link identifier is displayed; and

it can be understood that, to facilitate seeing the link identifier by a user, in the embodiment, after the link identifier is generated based on the website home page address and the address of the intelligent terminal, the link identifier is displayed, of course, the link identifier is generally displayed on a location that can be easily seen by the user on a display interface of the intelligent terminal, for example, the lower right corner of the display interface of the intelligent terminal.

S501: when receiving an access request including a website home page address and sent by a mobile terminal according to the link identifier, a website home page corresponding to the website home page address is sent to the mobile terminal, wherein the link identifier is generated based on the website home page address and the address of the intelligent terminal; and

step S501 in the embodiment is the same as step S401 in the embodiment as shown in FIG. 4, and thus will not be repeated redundantly herein.

S502: a webpage address of a webpage to be browsed sent by the mobile terminal is received, wherein the webpage address of the webpage to be browsed is determined by an instruction input by the user on the website home page; and

in specific implementation, the communication between the intelligent terminal and the mobile terminal is generally a data packet based on HTTP, so the webpage address of the webpage to be browsed is generally sent by the data packet.

S503: the webpage to be browsed is obtained based on the webpage address of the webpage to be browsed, and the webpage to be browsed is displayed.

Since the data packet is a data packet based on HTTP, HTTP analysis can be carried out on the data packet, the HTTP analysis generally includes Header analysis and Body analysis, the Body analysis is divided into a PUT type and a POST type according to request mode, the analysis process is a relatively mature technology, and thus will not be repeated redundantly herein.

For simple description, the method embodiments are expressed as a series of action combinations, but those skilled in the art should be aware that the embodiments of the present disclosure are not limited by the described action sequence, so according to the embodiments of the present disclosure, some steps can be carried out in other sequences or at the same time. Secondly, those skilled in the art should also be aware that the embodiments described in the description are all optional embodiments, and the involved actions are not necessarily essential to the embodiments of the present disclosure.

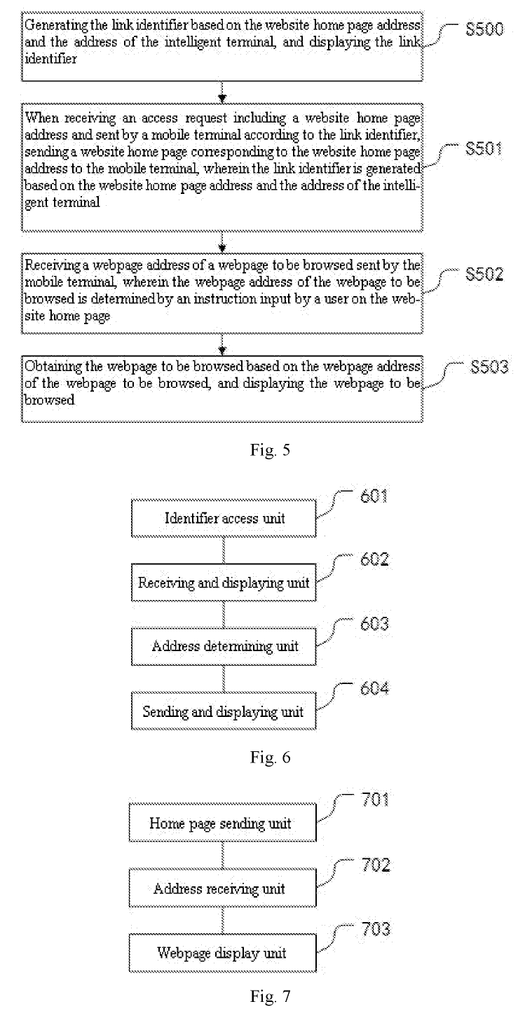

FIG. 6 is a structural block diagram of a mobile terminal provided by one embodiment of the present disclosure. Refer to FIG. 6, the mobile terminal includes:

an identifier access unit 601, used for sending an access request including a website home page address to an intelligent terminal according to a link identifier, wherein the link identifier is generated based on the website home page address and the address of the intelligent terminal;

a receiving and displaying unit 602, used for receiving and displaying a website home page corresponding to the website home page address sent by the intelligent terminal;

an address determining unit 603, used for detecting an instruction input by a user on the website home page and determining a webpage address of a webpage to be browsed according to the instruction; and

a sending and displaying unit 604, used for sending the webpage address of the webpage to be browsed to the intelligent terminal, thus allowing the intelligent terminal to display the webpage to be browsed corresponding to the webpage address of the webpage to be browsed.

In an optional embodiment of the present disclosure, the address determining unit is further used for detecting a click instruction input by the user on the website home page, and determining the webpage address of the webpage to be browsed according to the click instruction;

or,

detecting a webpage address input by the user on the website home page, and using the input webpage address as the webpage address of the webpage to be browsed.

In an optional embodiment of the present disclosure, the sending and displaying unit is further used for sending the webpage address of the webpage to be browsed to the intelligent terminal, after the user triggers a preset element on the website home page.

In an optional embodiment of the present disclosure, the identifier access unit is further used for scanning the link identifier to send the access request including the website home page address to the intelligent terminal, and the link identifier is a two-dimension code.

FIG. 7 is a structural block diagram of an intelligent terminal provided by one embodiment of the present disclosure. Refer to FIG. 7, the intelligent terminal includes:

a home page sending unit 701, used for, when receiving an access request including a website home page address and sent by a mobile terminal according to a link identifier, sending a website home page corresponding to the website home page address to the mobile terminal, wherein the link identifier is generated based on the website home page address and the address of the intelligent terminal;

an address receiving unit 702, used for receiving a webpage address of a webpage to be browsed sent by the mobile terminal, wherein the webpage address of the webpage to be browsed is determined by an instruction input by a user on the web site home page; and

a webpage display unit 703, used for obtaining the webpage to be browsed based on the webpage address of the webpage to be browsed and displaying the webpage to be browsed.

In an optional embodiment of the present disclosure, the intelligent terminal further includes:

an identifier generation unit, used for generating the link identifier based on the website home page address and the address of the intelligent terminal, and displaying the link identifier, wherein the link identifier is a two-dimension code.

Another embodiment of the present disclosure further discloses a computer program, including program codes, wherein the program codes are used for executing the following operations:

sending an access request including a website home page address to an intelligent terminal according to a link identifier, wherein the link identifier is generated based on the website home page address and the address of the intelligent terminal;

receiving and displaying a website home page corresponding to the website home page address sent by the intelligent terminal;

detecting an instruction input by a user on the website home page, and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

Another embodiment of the present disclosure further discloses a storage medium, used for storing the above computer program.

The embodiment of the present disclosure further discloses an apparatus, including:

one or more processors;

a memory;

one or more program modules;

wherein the one or more program modules are stored in the memory, and when being executed by the one or more processors, the one or more program modules execute the following operations:

sending an access request including a website home page address to an intelligent terminal according to a link identifier, wherein the link identifier is generated based on the website home page address and the address of the intelligent terminal;

receiving and displaying a website home page corresponding to the website home page address sent by the intelligent terminal;

detecting an instruction input by a user on the website home page, and determining a webpage address of a webpage to be browsed according to the instruction; and

sending the webpage address of the webpage to be browsed to the intelligent terminal, thus allowing the intelligent terminal to display the webpage to be browsed corresponding to the webpage address of the webpage to be browsed.

Another embodiment of the present disclosure further discloses a computer program, including program codes, wherein the program codes are used for executing the following operations:

when receiving an access request including a website home page address and sent by a mobile terminal according to a link identifier, sending a website home page corresponding to the website home page address to the mobile terminal, wherein the link identifier is generated based on the website home page address and the address of the intelligent terminal;

receiving a webpage address of a webpage to be browsed sent by the mobile terminal, wherein the webpage address of the webpage to be browsed is determined by an instruction input by a user on the web site home page; and

obtaining the webpage to be browsed based on the webpage address of the webpage to be browsed, and displaying the webpage to be browsed.

Another embodiment of the present disclosure further discloses a storage medium, used for storing the above computer program.

The embodiment of the present disclosure further discloses an apparatus, including:

one or more processors;

a memory;

one or more program modules;

wherein the one or more program modules are stored in the memory, and when being executed by the one or more processors, the one or more program modules execute the following operations:

when receiving an access request including a website home page address and sent by a mobile terminal according to a link identifier, sending a website home page corresponding to the website home page address to the mobile terminal, wherein the link identifier is generated based on the website home page address and the address of the intelligent terminal;

receiving a webpage address of a webpage to be browsed sent by the mobile terminal, wherein the webpage address of the webpage to be browsed is determined by an instruction input by a user on the web site home page; and

obtaining the webpage to be browsed based on the webpage address of the webpage to be browsed, and displaying the webpage to be browsed.

In summary, according to the webpage display method based on the link identifier, the mobile terminal, the intelligent terminal, the computer program, the storage medium and the apparatus provided by the embodiments of the present disclosure, the mobile terminal sends the access request including the website home page address to the intelligent terminal according to the link identifier, receives and displays the website home page corresponding to the website home page address sent by the intelligent terminal, detects the instruction input by the user on the website home page, determines the webpage address of the webpage to be browsed according to the instruction, and sends the webpage address of the webpage to be browsed to the intelligent terminal, thus allowing the intelligent terminal to display the webpage to be browsed corresponding to the webpage address of the webpage to be browsed. By adopting the above technical solutions, the user can operate on the mobile terminal to display the webpage to be browsed on the intelligent terminal, so that the operation is convenient and the user experience is improved.

The apparatus embodiments described above are merely exemplary, wherein units described as separate components can be separated physically or not, components displayed as units can be physical units or not, namely, can be located in one place, or can be distributed on a plurality of network units. A part of or all modules can be selected according to actual demand to achieve the objects of the solutions in the embodiments. Those of ordinary skill in the art can understand and implement the objects without any creative effort.

Those of ordinary skill in the art can understand that all or a part of the steps in the above method embodiment can be implemented by a program instruction related hardware, the foregoing program can be stored in a computer readable storage medium, and when being executed, the program can execute the steps including the above method embodiment; and the foregoing storage medium includes various media capable of storing program codes, such as a ROM, a RAM, a magnetic disk or an optical disk, etc.

Finally, it should be noted that the above-mentioned embodiments are merely used for illustrating, rather than limiting the technical solutions of the embodiments of the present disclosure; although the embodiments of the present disclosure have been described in detail with reference to the foregoing embodiments, those of ordinary skill in the art should understand that they could still make modifications to the technical solutions stated in the foregoing embodiments or make equivalent substitutions to a part of or all technical features therein; and these modifications or substitutions do not make the essence of the corresponding technical solutions depart from the scope of the technical solutions of the embodiments of the present disclosure.

What is claimed is:

1. A mobile terminal, comprising:
at least one processor; and
a memory communicably connected with the at least one processor for storing instructions executable by the at least one processor, wherein execution of the instructions by the at least one processor causes the at least one processor to:
send an access request comprising a website home page address to an intelligent terminal according to a link identifier, wherein the link identifier is generated based on the website home page address and the address of the intelligent terminal;
receive and display a website home page corresponding to the website home page address sent by the intelligent terminal;
detect an instruction input by a user on the website home page and determine a webpage address of a webpage to be browsed according to the instruction; and
send the webpage address of the webpage to be browsed to the intelligent terminal, thus allow the intelligent terminal to display the webpage to be browsed corresponding to the webpage address of the webpage to be browsed.

2. The mobile terminal of claim 1, wherein the at least one processor is further caused to:
detect a click instruction input by the user on the website home page, and determine the webpage address of the webpage to be browsed according to the click instruction;
or,
detect a webpage address input by the user on the website home page, and use the input webpage address as the webpage address of the webpage to be browsed.

3. The mobile terminal of claim 1, wherein the at least one processor is further caused to:
send the webpage address of the webpage to be browsed to the intelligent terminal, after the user triggers a preset element on the web site home page.

4. The mobile terminal of claim 1, wherein the at least one processor is further caused to:
scan the link identifier to send the access request comprising the website home page address to the intelligent terminal, and the link identifier is a two-dimension code.

5. A webpage display method based on a link identifier, comprising:
sending an access request comprising a website home page address to an intelligent terminal according to the link identifier, wherein the link identifier is generated based on the website home page address and the address of the intelligent terminal;
receiving and displaying a website home page corresponding to the website home page address sent by the intelligent terminal;
detecting an instruction input by a user on the website home page, and determining a webpage address of a webpage to be browsed according to the instruction; and
sending the webpage address of the webpage to be browsed to the intelligent terminal, thus allowing the intelligent terminal to display the webpage to be browsed corresponding to the webpage address of the webpage to be browsed.

6. The method of claim 5, wherein the detecting an instruction input by a user on the website home page, and determining a webpage address of a webpage to be browsed according to the instruction further comprises:
detecting a click instruction input by the user on the website home page, and
determining the webpage address of the webpage to be browsed according to the click instruction;
or,
detecting a webpage address input by the user on the website home page, and using the input webpage address as the webpage address of the webpage to be browsed.

7. The method of claim 5, wherein the sending the webpage address of the webpage to be browsed to the intelligent terminal further comprises:
sending the webpage address of the webpage to be browsed to the intelligent terminal, after the user triggers a preset element on the website home page.

8. The method of claim 5, wherein the sending an access request comprising a website home page address to an intelligent terminal according to the link identifier further comprises:
scanning the link identifier to send the access request comprising the website home page address to the intelligent terminal, the link identifier being a two-dimension code.

9. An intelligent terminal, comprising:
at least one processor; and
a memory communicably connected with the at least one processor for storing instructions executable by the at least one processor, wherein execution of the instructions by the at least one processor causes the at least one processor to:
when receive an access request comprising a website home page address and sent by a mobile terminal according to a link identifier, send a website home page corresponding to the website home page address to the mobile terminal, wherein the link identifier is generated based on the website home page address and the address of the intelligent terminal;
receive a webpage address of a webpage to be browsed sent by the mobile terminal, wherein the webpage address of the webpage to be browsed is determined by an instruction input by a user on the website home page; and
obtain the webpage to be browsed based on the webpage address of the webpage to be browsed and displaying the webpage to be browsed.

10. The intelligent terminal of claim 9, wherein the at least one processor is further caused to:
generate the link identifier based on the website home page address and the address of the intelligent terminal, and display the link identifier, wherein the link identifier is a two-dimension code.

11. A webpage display method based on a link identifier, comprising:
when receiving an access request comprising a website home page address and sent by a mobile terminal according to the link identifier, sending a website home page corresponding to the website home page address to the mobile terminal, wherein the link identifier is generated based on the website home page address and the address of the intelligent terminal;
receiving a webpage address of a webpage to be browsed sent by the mobile terminal, wherein the webpage address of the webpage to be browsed is determined by an instruction input by a user on the website home page; and
obtaining the webpage to be browsed based on the webpage address of the webpage to be browsed, and displaying the webpage to be browsed.

12. The method of claim 11, wherein before the when receiving an access request comprising a website home page address and sent by a mobile terminal according to the link identifier, sending a website home page corresponding to the website home page address to the mobile terminal, the method further comprises:
generating the link identifier based on the website home page address and the address of the intelligent terminal, and displaying the link identifier, wherein the link identifier is a two-dimension code.
